(19) United States
(12) Patent Application Publication
(10) Pub. No.: US 2026/0148712 A1
(43) Pub. Date: May 28, 2026

(54) PAIR OF DISPLAY DEVICES AND DISPLAY SYSTEM

(71) Applicant: Japan Display Inc., Tokyo (JP)

(72) Inventor: Hitoshi TANAKA, Tokyo (JP)

(73) Assignee: Japan Display Inc., Tokyo (JP)

(21) Appl. No.: 19/393,704

(22) Filed: Nov. 19, 2025

(30) Foreign Application Priority Data
Nov. 22, 2024 (JP) 2024-203622

(51) Int. Cl. G09G 3/36; G02F 1/1362

(52) U.S. Cl. CPC G09G 3/3614; G02F 1/136286; G09G 3/3666; G09G 2300/0426

(57) ABSTRACT

According to an aspect, a pair of display devices includes a first display device and a second display device arranged along an array direction. The first display device and the second display device each include: a display panel having a display area provided with sub-pixels; gate lines extending along the row direction and arrayed along the column direction; signal lines extending along the column direction and arrayed along the row direction; and a drive circuit. An arrangement of the sub-pixels in the display area of the first display device and an arrangement of the sub-pixels in the display area of the second display device are line symmetrical with respect to a virtual line orthogonal to the array direction. An arrangement of the signal lines of the first display device and an arrangement of the signal lines of the second display device are line symmetrical with respect to the virtual line.

### CROSS-REFERENCE TO RELATED APPLICATION

This application claims the benefit of priority from Japanese Patent Application No. 2024-203622 filed on Nov. 22, 2024, the entire contents of which are incorporated herein by reference.

### BACKGROUND

### 1. Technical Field

What is disclosed herein relates to a pair of display devices and a display system.

### 2. Description of the Related Art

Japanese Patent Application Laid-open Publication No. 2021-162841 (JP-A-2021-162841) discloses a display system with two display panels. The two display panels each include a plurality of pixels arrayed along a direction Vx and a direction Vy in a display area and a plurality of signal lines. Each signal line is disposed between two pixels adjacent to each other in the direction Vx and extends along the direction Vy. In other words, one pixel is sandwiched between two signal lines in the direction Vx. The pixel is supplied with pixel signal via the signal line, and a holding capacitance is formed corresponding to the pixel signal. The gradation level of the pixel is dependent on the holding capacitance.

When the display system disclosed in JP-A-2021-162841 is applied to a head-mounted display (which may be hereinafter referred to as HMD), for example, the size of the pixels may be determined to be relatively small. In this case, the distance between two signal lines adjacent to each other in the direction Vx is also relatively small. As a result, the holding capacitance formed in the pixel may be affected by the potentials of the two signal lines. In other words, the holding capacitance may change due to the potentials of the two signal lines.

When the holding capacitance changes as described above in a certain pixel of the display panel, the gradation level of the pixel changes. Therefore, when the same image is displayed on two display panels (a pair of display devices), the difference between the gradation level of the certain pixel in a first display device and that of the pixel corresponding to the certain pixel in a second display device may be relatively large depending on the arrangement of the pixels. In this case, the difference in chromaticity is relatively large between the certain pixel in the first display device and the pixel corresponding to the certain pixel in the second display device. In other words, when the same image is displayed on each one of the pair of display devices, the difference in chromaticity may be relatively large between the images displayed on the pair of display devices.

For the foregoing reasons, there is a need for reducing the difference in chromaticity between images displayed on a pair of display devices when the same image is displayed on each one of the pair of display devices.

### SUMMARY

According to an aspect, a pair of display devices includes a first display device and a second display device arranged along an array direction. The first display device and the second display device each include: a display panel having a display area in which a plurality of sub-pixels are arrayed in a matrix having a row-column configuration along a row direction and a column direction; a plurality of gate lines provided to the display panel, extending along the row direction, and arrayed along the column direction; a plurality of signal lines provided to the display panel, extending along the column direction, and arrayed along the row direction; and a drive circuit configured to output sub-pixel signals for displaying an image in the display area to the sub-pixels via the signal lines and drive the sub-pixels via the gate lines. The sub-pixels include a plurality of first sub-pixels, a plurality of second sub-pixels, and a plurality of third sub-pixels having different colors. The first sub-pixels, the second sub-pixels, and the third sub-pixels are arranged in the display area of the first display device such that the first sub-pixel, the second sub-pixel, and the third sub-pixel are repeatedly disposed along the row direction in the order as listed and that the first sub-pixel, the second sub-pixel, and the third sub-pixel are repeatedly disposed along the column direction in the order as listed. An arrangement of the sub-pixels in the display area of the first display device and an arrangement of the sub-pixels in the display area of the second display device are line symmetrical with respect to a virtual line orthogonal to the array direction. An arrangement of the signal lines of the first display device and an arrangement of the signal lines of the second display device are line symmetrical with respect to the virtual line.

According to an aspect, a display system includes the pair of display devices and a lens.

### BRIEF DESCRIPTION OF THE DRAWINGS

FIG. 1 is a front view of a pair of display devices according to an embodiment of the present disclosure;

FIG. 2 is a side view of the display device;

FIG. 3 is a diagram of a circuit configuration of a display panel;

FIG. 4 is a diagram of a circuit configuration of sub-pixels;

FIG. 5 is a sectional view of the display panel;

FIG. 6 is a diagram of an array of the sub-pixels and an arrangement of signal lines in a second display device;

FIG. 7 is a timing chart of an operation of the display device;

FIG. 8 is a partial enlarged view of the circuit configuration of the display panel of a first display device;

FIG. 9 is a partial enlarged view of the circuit configuration of the display panel of the second display device;

FIG. 10 is a partial enlarged view of the circuit configuration of a display panel of a second display device in a pair of display devices according to a comparative example;

FIG. 11 is a diagram of the circuit configuration of the display panel included in the first display device in the pair of display devices according to a modification of the embodiment of the present disclosure;

FIG. 12 is a diagram of the circuit configuration of the display panel included in the second display device in the pair of display devices according to the modification of the embodiment of the present disclosure;

FIG. 13 is a diagram of a state where a drive circuit included in the display device outputs sub-pixel signals by a second column inversion driving method in the pair of display devices according to a modification of the embodiment of the present disclosure;

FIG. 14 is a perspective view of a display system according to the embodiment of the present disclosure;

FIG. 15 is a schematic diagram of the configuration of the display system; and

FIG. 16 is a schematic diagram of an arrangement of the pair of display devices in a wearable part.

### DETAILED DESCRIPTION

An exemplary embodiment of the present disclosure is described below with reference to the accompanying drawings. The content described in the embodiment below is not intended to limit the present disclosure. Components described below include components easily conceivable by those skilled in the art and components substantially identical therewith. Furthermore, the components described below may be appropriately combined.

What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each component more schematically than the actual aspect. These elements, however, are given by way of example only and are not intended to limit interpretation of the present disclosure. In the present specification and the figures, components similar to those previously described with reference to previous figures are denoted by the same reference numerals, and detailed explanation thereof may be appropriately omitted.

### Pair of Display Devices 1

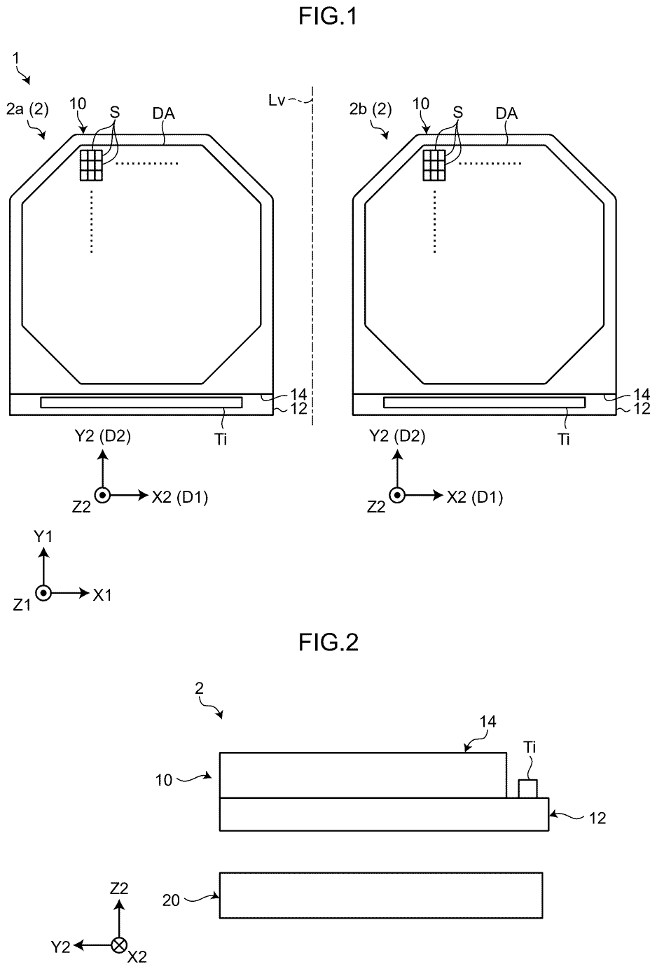

FIG. 1 is a front view of a pair of display devices 1 according to an embodiment of the present disclosure. An X1-direction (corresponding to an “array direction”), a Y1-direction, and a Z1-direction illustrated in the drawings are orthogonal to each other and indicate the directions with respect to the pair of display devices 1. The X1-, Y1-, and Z1-directions are given by way of example only and are not intended to limit the present disclosure.

The pair of display devices 1 displays images based on image signals transmitted from an external device. The pair of display devices 1 includes a first display device 2a and a second display device 2b. The first display device 2a and the second display device 2b are disposed side by side along the X1-direction.

The first display device 2a and the second display device 2b have the same configuration except for the array of sub-pixels S and the arrangement of signal lines Lb, which will be described later. In the following description, the first display device 2a and the second display device 2b are referred to simply as a “display device 2” when they are not distinguished from each other.

FIG. 2 is a side view of the display device 2. X2-, Y2-, and Z2-directions illustrated in the drawings are orthogonal to each other and indicate the directions with respect to the display device 2. The X2- and Y2-directions correspond to the directions parallel to the main surface of a substrate included in the display device 2. The Z2-direction corresponds to the direction orthogonal to the main surface of the substrate included in the display device 2. The Z2-direction corresponds to the thickness direction of the display device 2. The +Z2 side (side to which the arrow points) in the Z2-direction corresponds to the front surface side where images are displayed in the display device 2, and the −Z2 side (side opposite to the side to which the arrow points) in the Z2-direction corresponds to the back surface side of the display device 2. Viewing the display device 2 along the Z2-direction is referred to as “plan view”. The X2-, Y2-, and Z2-directions are given by way of example only and are not intended to limit the present disclosure.

The display device 2 includes a display panel 10 and a lighting device 20. The display panel 10 is a transmissive liquid crystal display.

As illustrated in FIG. 1, the display panel 10 has a display area DA that is provided on the front surface and in which images are displayed. The front surface of the display panel 10 is orthogonal to the Z2-direction. While the display area DA has a polygonal shape in plan view, it may have a rectangular shape.

A plurality of sub-pixels S are arrayed in a matrix (row-column configuration) in the display area DA. The sub-pixels S are arrayed in a matrix (row-column configuration) along a row direction D1 and a column direction D2 in plan view. The row direction D1 and the column direction D2 are orthogonal to each other. The row direction D1 is parallel to the X2-direction. The column direction D2 is parallel to the Y2-direction. The row direction D1 may be inclined with respect to the X2-direction, and the column direction D2 may be inclined with respect to the Y2-direction. The row direction D1 and the column direction D2 may be inclined instead of being orthogonal to each other. The sub-pixel S will be described later in greater detail.

As illustrated in FIG. 2, the lighting device 20 is disposed on the back surface side of the display panel 10 and emits light toward the display panel 10. The lighting device 20 is what is called a direct-type backlight. The lighting device 20 includes a plurality of light-emitting diodes, for example.

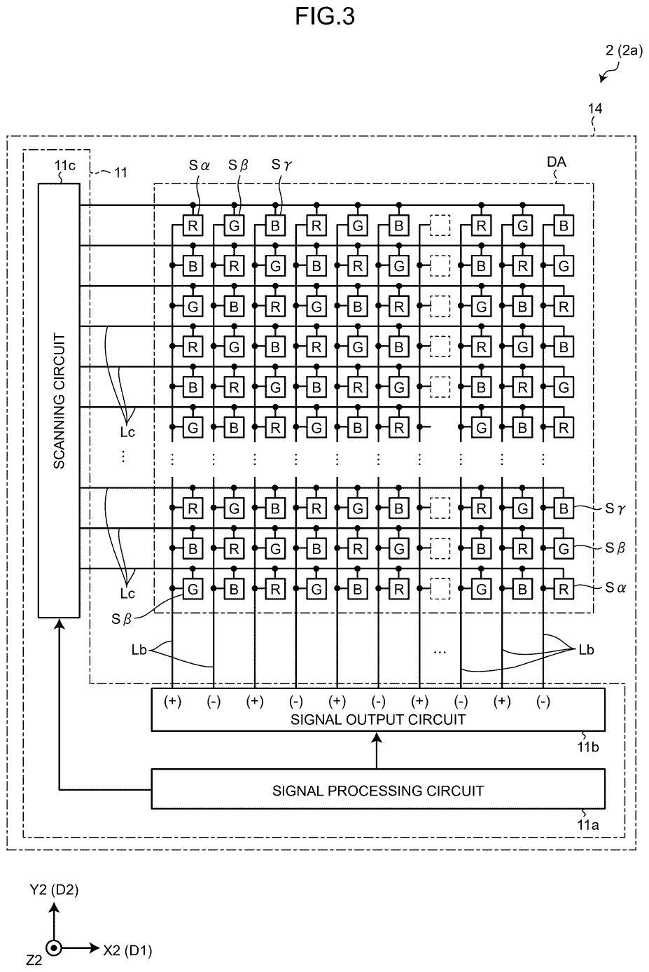

FIG. 3 is a diagram of a circuit configuration of the display panel 10. The display panel 10 includes a drive circuit 11 illustrated in FIG. 3.

The drive circuit 11 displays images in the display area DA. As illustrated in FIG. 3, the drive circuit 11 includes a signal processing circuit 11a, a signal output circuit 11b, and a scanning circuit 11c.

The signal processing circuit 11a generates a plurality of sub-pixel signals, which will be described later, based on the image signals transmitted from the external device and outputs the generated sub-pixel signals to the signal output circuit 11b. The signal processing circuit 11a outputs, to the signal output circuit 11b and the scanning circuit 11c, clock signals for synchronizing the operation of the signal output circuit 11b with the operation of the scanning circuit 11c.

The signal output circuit 11b outputs the sub-pixel signals to the respective sub-pixels S. The signal output circuit 11b and the sub-pixels S are electrically coupled via a plurality of signal lines Lb extending along the column direction D2 (which will be described later). The signal lines Lb are arrayed along the row direction D1. The signal lines Lb and the sub-pixels S are alternately arranged in the row direction D1.

The signal output circuit 11b outputs the sub-pixel signals by the column inversion driving method in which the polarities of the sub-pixel signals are different between two signal lines Lb adjacent to each other in the row direction D1 and the polarities of the sub-pixel signals are periodically inverted (e.g., every one frame F).

For example, as represented by the symbols in the parentheses in FIG. 3, when the polarity of the sub-pixel signals corresponding to the signal line Lb on the most −D1 side is positive (+), the polarity of the sub-pixel signals corresponding to the next signal line Lb is negative (−). In other words, the polarities of the sub-pixel signals corresponding to the signal lines Lb are alternately positive and negative in the row direction D1.

The scanning circuit 11c scans a plurality of sub-pixels S in synchronization with the output of the sub-pixel signals by the signal output circuit 11b. The scanning circuit 11c and the sub-pixels S are electrically coupled via a plurality of gate lines Lc extending along the row direction D1. Each gate line Lc is electrically coupled to a plurality of sub-pixels S arrayed in the same row along the row direction D1. The gate lines Lc are arrayed along the column direction D2.

The drive circuit 11 outputs the sub-pixel signals for displaying images in the display area DA to the sub-pixels S via the signal lines Lb and drives the sub-pixels S via the gate lines Lc.

The area partitioned by two signal lines Lb adjacent to each other in the row direction D1 and two gate lines Lc adjacent to each other in the column direction D2 in plan view corresponds to one sub-pixel S.

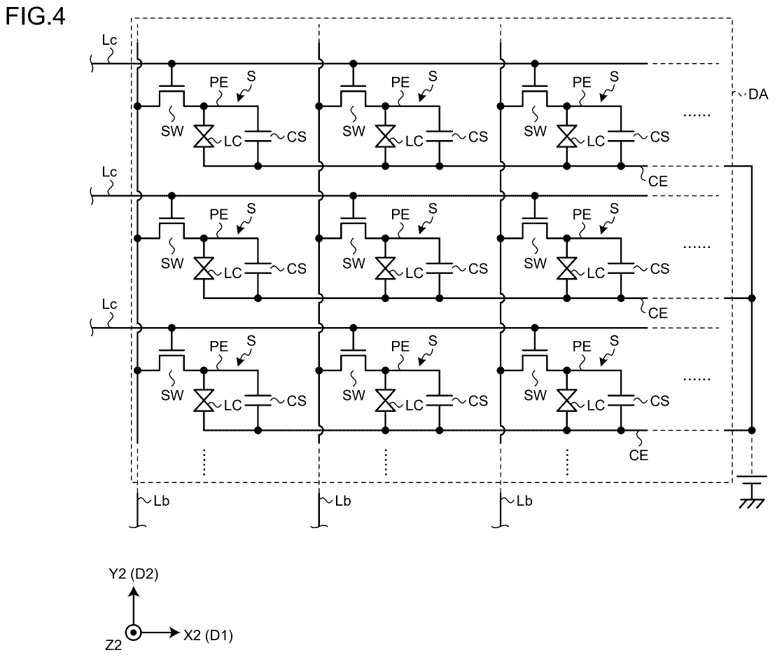

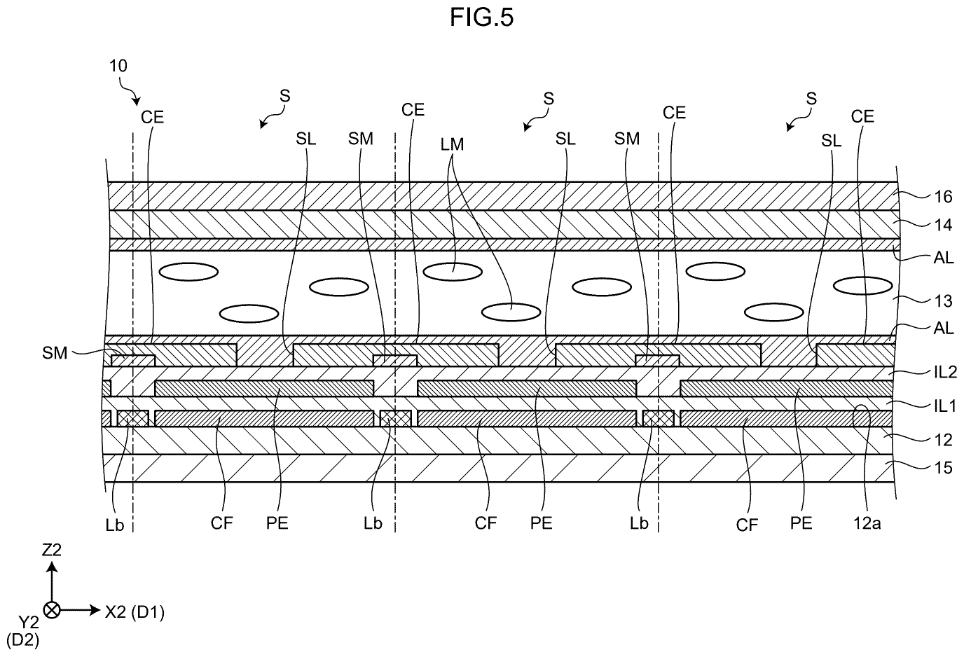

FIG. 4 is a diagram of a circuit configuration of the sub-pixels S. The display panel 10 includes a switching element SW, a sub-pixel electrode PE, a common electrode CE, and a liquid crystal capacitance LC included in each of the sub-pixels S.

The switching element SW is composed of a thin-film transistor (TFT), for example. In the switching element SW, the source electrode is electrically coupled to the signal line Lb, and the gate electrode is electrically coupled to the gate line Lc.

The sub-pixel electrode PE is coupled to the drain electrode of the switching element SW. The common electrode CE is disposed corresponding to the sub-pixel electrode PE. The sub-pixel electrode PE and the common electrode CE have a light-transmitting property.

The liquid crystal capacitance LC is a capacitance component of the liquid crystal material of a liquid crystal layer 13, which will be described later, between the sub-pixel electrode PE and the common electrode CE. A holding capacitance CS is formed between the electrode with the same potential as that of the common electrode CE and the electrode with the same potential as that of the sub-pixel electrode PE.

FIG. 5 is a sectional view of the display panel 10. The display panel 10 includes a first substrate 12, a liquid crystal layer 13, and a second substrate 14.

The first substrate 12, the liquid crystal layer 13, and the second substrate 14 have a light-transmitting property and are disposed in this order along the Z2-direction from the −Z2 side to the +Z2 side in the Z2-direction. The first substrate 12 is provided with an IC chip Ti constituting the drive circuit 11 (refer to FIGS. 1 and 2).

A main surface 12a corresponding to the front surface of the first substrate 12 is provided with the signal lines Lb and the gate lines Lc (not illustrated in FIG. 5). The main surface 12a of the first substrate 12 is also provided with color filters CF. The color filters CF each have a rectangular shape in plan view and are disposed corresponding to the respective sub-pixels S.

The color filter CF has a light-transmitting property, and the peak of the spectrum of light to be transmitted through the color filter CF is determined in advance. The peak of the spectrum is one of the peaks of three spectra corresponding to three different colors. While the three colors are red, green, and blue, the number and type of colors are not limited thereto. In the following description, the color corresponding to the peak of the spectrum of light transmitted by the color filter CF is referred to as the color of the color filter CF. The color of the color filter CF corresponds to that of the sub-pixel S.

The first substrate 12 is also provided with the sub-pixel electrodes PE on the +Z2 side in the Z2-direction of the color filters CF and the signal lines Lb with an insulating layer IL1 interposed therebetween. The sub-pixel electrode PE overlaps the color filter CF in the Z2-direction.

The first substrate 12 is also provided with a light-shielding film SM, the common electrode CE, and an orientation film AL on the +Z2 side in the Z2-direction of the sub-pixel electrodes PE with an insulating layer IL2 interposed therebetween.

The light-shielding film SM has a light-shielding property. The light-shielding film SM overlaps the signal lines Lb and the gate lines Lc in the Z2-direction. Specifically, the light-shielding film SM partitions the sub-pixels S. In other words, when viewed along the Z2-direction, the light-shielding film SM overlaps with the boundary of two sub-pixels S adjacent to each other in the row direction D1 and with the boundary of two sub-pixels S adjacent to each other in the column direction D2.

The common electrode CE is stacked on the light-shielding film SM, has slits SL, and is disposed to extend across two sub-pixel electrodes PE adjacent to each other in plan view. Thus, the common electrode CE and the sub-pixel electrodes PE are disposed on the first substrate 12. In other words, the display panel 10 is a lateral electric field liquid crystal display.

The liquid crystal layer 13 includes a plurality of liquid crystal molecules LM. The liquid crystal layer 13 is provided between two orientation films AL facing each other in the Z2-direction. The orientation of the liquid crystal molecules LM is regulated by the two orientation films AL. An orientation film AL is disposed on the back surface side of the second substrate 14.

The display panel 10 further includes a first polarizing plate 15 disposed on the back surface side of the first substrate 12 and a second polarizing plate 16 disposed on the front surface side of the second substrate 14.

The first polarizing plate 15 has a transmission axis orthogonal to the Z2-direction. The second polarizing plate 16 has a transmission axis orthogonal to the transmission axis of the first polarizing plate 15 and the Z2-direction.

As illustrated in FIG. 1, the display device 2 in the pair of display devices 1 is disposed with the X2-direction and the X1-direction parallel to each other, the Y2-direction and the Y1-direction parallel to each other, and the Z2-direction and the Z1-direction parallel to each other. When a line extending between the first display device 2a and the second display device 2b and orthogonal to the X1-direction is defined as a virtual line Lv, the periphery of the display area DA of the first display device 2a and that of the display area DA of the second display device 2b are line symmetrical with respect to the virtual line Lv.

Next, the array of the sub-pixels S and the arrangement of the signal lines Lb in the first display device 2a are described.

FIG. 3 illustrates the array of the sub-pixels S and the arrangement of the signal lines Lb in the first display device 2a. As described above, the sub-pixels S are arrayed in a matrix (row-column configuration) along the row direction D1 and the column direction D2 in plan view.

The sub-pixels S include a plurality of first sub-pixels Sα, a plurality of second sub-pixels Sβ, and a plurality of third sub-pixels Sγ. The first sub-pixel Sα, the second sub-pixel Sβ, and the third sub-pixel Sγ have the color filters CF that are different in color, that is, the colors of these sub-pixels S are different from each other. The color of the first sub-pixel Sα is red. The color of the second sub-pixel Sβ is green. The color of the third sub-pixel Sγ is blue. In other words, the first sub-pixel Sα is a red sub-pixel. The second sub-pixel Sβ is a green sub-pixel. The third sub-pixel Sγ is a blue sub-pixel.

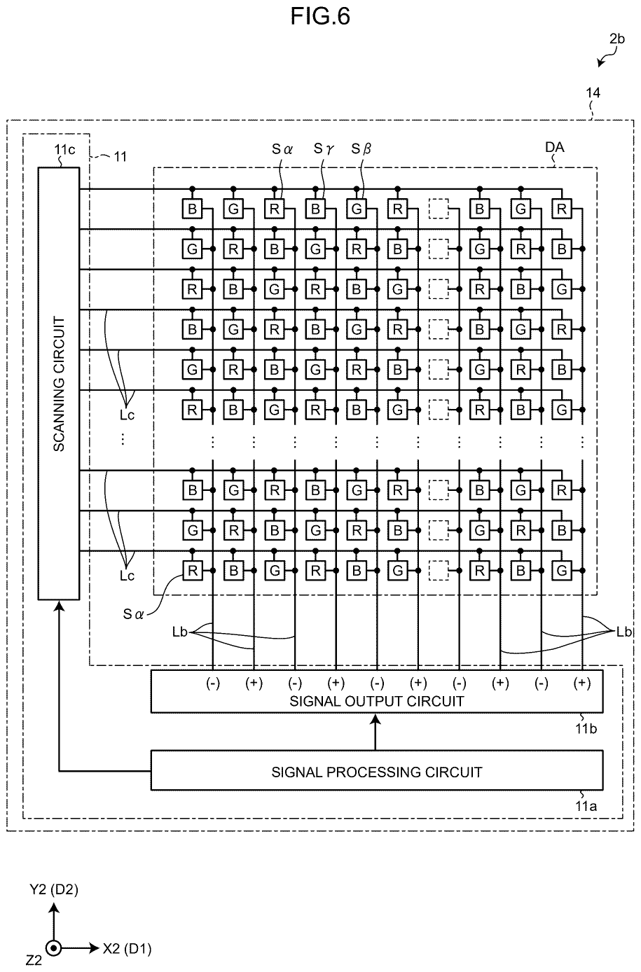

In FIG. 3 and FIG. 6, which will be described later, the first sub-pixel Sα is represented by “R”, the second sub-pixel Sβ is represented by “G”, and the third sub-pixel Sγ is represented by “B”. The colors of the sub-pixels S are not limited thereto. In the following description, the first sub-pixel Sα, the second sub-pixel Sβ, and the third sub-pixel Sγ may be referred to simply as the “sub-pixel S” when they are not distinguished from one another.

The array of the sub-pixels S illustrated in FIG. 3 is what is called a mosaic array. Specifically, the first sub-pixel Sα, the second sub-pixel Sβ, and the third sub-pixel Sγ are repeatedly disposed in this order along the row direction D1 from the −D1 side (side opposite to the side to which the arrow points) to the +D1 side (side to which the arrow points) in the row direction D1 in plan view, and the first sub-pixel Sα, the second sub-pixel Sβ, and the third sub-pixel Sγ are repeatedly disposed in this order along the column direction D2 from the −D2 side (side opposite to the side to which the arrow points) to the +D2 side (side to which the arrow points) in the column direction D2.

In FIG. 3, the sub-pixels S are arrayed in ascending order from the first column to the m-th column (m is a natural number) along the row direction D1 from a first end (end on the −D1 side) to a second end (end on the +D1 side) and are arrayed in ascending order from the first row to the n-th row (n is a natural number) along the column direction D2 from a first end (end on the −D2 side) to a second end (end on the +D2 side). While the sub-pixel S in the first row and the first column according to the present embodiment is the second sub-pixel Sβ, the sub-pixel S in the first row and the first column may be the first sub-pixel Sα or the third sub-pixel Sγ.

In the stripe array, which is one of the array types of the sub-pixels S, the first sub-pixel Sα, the second sub-pixel Sβ, and the third sub-pixel Sγ are repeatedly disposed in this order along the row direction D1 from the −D1 side to the +D1 side in the row direction D1, and the sub-pixels S of the same color are continuously arrayed in the column direction D2. The distance between two sub-pixels S adjacent to each other in the row direction D1 and the column direction D2 can be made smaller in the mosaic array than in the stripe array. Therefore, the mosaic array can produce a higher-definition image than the stripe array can.

As described above, the signal lines Lb extend along the column direction D2 and are arrayed along the row direction D1. The signal lines Lb and the sub-pixels S are alternately arranged in the row direction D1. When M is the total number of sub-pixels S arrayed in ascending order from the first column to the m-th column (m is a natural number) along the row direction D1 from the first end (end on the −D1 side) to the second end (end on the +D1 side), the total number of signal lines Lb is M.

The m-th signal line Lb is disposed on the −D1 side of a plurality of sub-pixels S arrayed in the m-th column. The m-th signal line Lb branches off and is electrically coupled to the sub-pixels S arrayed in the m-th column. The m-th signal line Lb may be disposed on the +D1 side of the sub-pixels S in the m-th column.

Next, the array of the sub-pixels S and the arrangement of the signal lines Lb in the second display device 2b are described.

FIG. 6 is a diagram of the array of the sub-pixels S and the arrangement of the signal lines Lb in the second display device 2b. Similarly to the first display device 2a, the sub-pixels S in the second display device 2b also include a plurality of first sub-pixels Sα, a plurality of second sub-pixels Sβ, and a plurality of third sub-pixels Sγ. The array of the sub-pixels S in the second display device 2b also corresponds to the mosaic array. The number of sub-pixels S of the second display device 2b is equal to that of sub-pixels S of the first display device 2a.

The array of the sub-pixels S of the second display device 2b has a difference from that of the sub-pixels S of the first display device 2a. Specifically, the arrangement of the sub-pixels S in the display area DA of the first display device 2a is different from that of the sub-pixels S in the display area DA of the second display device 2b because they are line symmetrical with respect to the virtual line Lv orthogonal to the X1-direction.

In the array of the sub-pixels S in the second display device 2b, the first sub-pixel Sα, the third sub-pixel Sγ, and the second sub-pixel Sβ are repeatedly disposed in this order along the row direction D1 from the −D1 side to the +D1 side in the row direction D1 in plan view, and the first sub-pixel Sα, the second sub-pixel Sβ, and the third sub-pixel Sγ are repeatedly disposed in this order along the column direction D2 from the −D2 side to the +D2 side in the column direction D2.

Similarly to the first display device 2a, the signal lines Lb in the second display device 2b also extend along the column direction D2 and are arrayed along the row direction D1. The number of signal lines Lb of the second display device 2b is equal to that of signal lines Lb of the first display device 2a. The signal lines Lb and the sub-pixels S are alternately arranged in the row direction D1. When M is the total number of sub-pixels S arrayed in ascending order from the first column to the m-th column (m is a natural number) along the row direction D1 from the first end (−D1 side) to the second end (+D1 side), the number of signal lines Lb is M.

The arrangement of the signal lines Lb of the second display device 2b has the following difference from that of the signal lines Lb of the first display device 2a. Specifically, the arrangement of the signal lines Lb of the first display device 2a is different from that of the signal lines Lb of the second display device 2b because they are line symmetrical with respect to the virtual line Lv.

The m-th signal line Lb is disposed on the +D1 side of a plurality of sub-pixels S arrayed in the m-th column. The m-th signal line Lb branches off and is electrically coupled to the sub-pixels S arrayed in the m-th column.

If the first signal line Lb in the first display device 2a is disposed on the +D1 side of the sub-pixels S in the first column, the first signal line Lb in the second display device 2b is disposed on the −D1 side of the sub-pixels S in the first column.

As represented by the symbols in the parentheses in FIG. 6, when the polarity of the sub-pixel signals corresponding to the signal line Lb on the most −D1 side is negative (−), the polarity of the sub-pixel signals corresponding to the next signal line Lb is positive (+) by the column inversion driving method described above. In other words, the polarities of the sub-pixel signals corresponding to the signal lines Lb are alternately positive and negative in the row direction D1.

Next, the operation of the display device 2 is described.

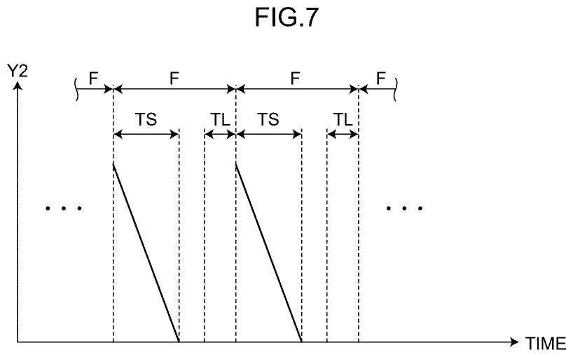

FIG. 7 is a timing chart of an operation of the display device 2. In FIG. 7, the horizontal axis indicates time, and the vertical axis indicates the position in the column direction D2 of the sub-pixels S in the display area DA. The display device 2 receives image signals and displays an image in each frame F.

The signal processing circuit 11a generates sub-pixel signals based on the image signals. The sub-pixel signal has information on the gradation level of the sub-pixel S. The information on the gradation level of the sub-pixel S is included in the image signal. One frame F includes a scanning period TS and a light emission period TL in this order.

The scanning circuit 11c scans a plurality of sub-pixels S in the scanning period TS. The scanning circuit 11c sequentially scans the sub-pixels S from the sub-pixel S on the most +D2 side to the sub-pixel S on the most −D2 side along the column direction D2. The solid line extending from the +D2 side to the −D2 side as time passes in the scanning period TS indicates that the scanning circuit 11c is scanning the sub-pixels S.

In the scanning period TS, the signal output circuit 11b outputs the sub-pixel signals corresponding to the sub-pixels S via the signal lines Lb. The sub-pixel signal causes the potential of the signal line Lb to change. When the sub-pixel signal is output to the sub-pixel S, the holding capacitance CS corresponding to the gradation level indicated by the sub-pixel signal is formed in the sub-pixel S. The liquid crystal molecules LM are inclined by the electric field generated between the sub-pixel electrode PE and the common electrode CE. The degree of inclination of the liquid crystal molecules LM varies depending on the gradation level indicated by the sub-pixel signals. When the scanning period TS ends, the potential of the signal line Lb becomes a reference potential (e.g., 0 V).

In the light emission period TL, the lighting device 20 emits light. Light emitted from the lighting device 20 is incident in the display panel 10. The light incident in the display panel 10 is colored by passing through the color filter CF and is incident in the liquid crystal layer 13. Due to the inclination of the liquid crystal molecules LM, the light passing through the liquid crystal layer 13 is modulated to the gradation level indicated by the sub-pixel signals. The light that has passed through the liquid crystal layer 13 is output from the display panel 10. As a result, an image is displayed in the display area DA.

In such a pair of display devices 1, the holding capacitance CS formed in the sub-pixel S sandwiched between two signal lines Lb adjacent to each other is affected by the potentials of the two signal lines Lb. For example, if the pitch of two sub-pixels S adjacent to each other is determined to be relatively small to produce a high-definition image, the distance between two signal lines Lb adjacent to each other is determined to be relatively small, and the effects of the potentials of the two signal lines Lb on the holding capacitance CS are relatively large.

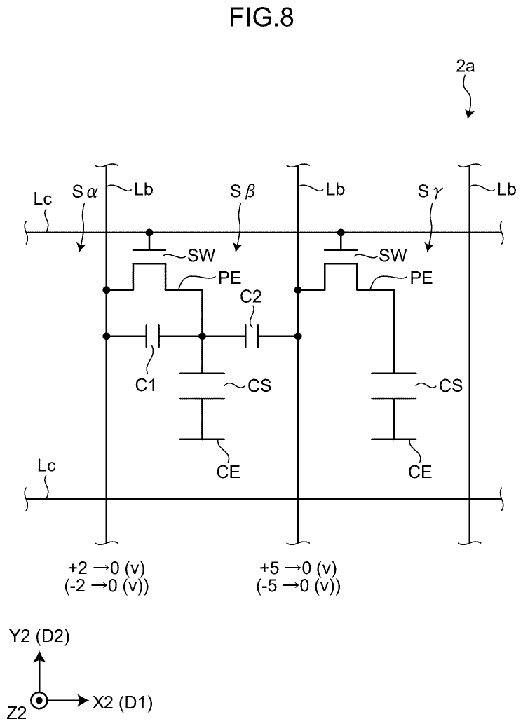

FIG. 8 is a partial enlarged view of the circuit configuration of the display panel 10 of the first display device 2a. FIG. 8 illustrates the second sub-pixel Sβ and the third sub-pixel Sγ electrically coupled to the same gate line Lc and adjacent to each other.

In the first display device 2a, the signal line Lb electrically coupled to the second sub-pixel Sβ is disposed on the −D1 side of the second sub-pixel Sβ, and the signal line Lb disposed on the +D1 side of the second sub-pixel Sβ is electrically coupled to the third sub-pixel Sγ adjacent to the second sub-pixel Sβ.

When the display device 2 displays cyan monochromatically in the entire display area DA, for example, the potential of the signal line Lb corresponding to the first sub-pixel Sα (red) is 0 V, the potential of the signal line Lb corresponding to the second sub-pixel Sβ (green) is +2 V (or −2 V: the polarity is inverted by the column inversion driving method), and the potential of the signal line Lb corresponding to the third sub-pixel Sγ (blue) is 5 V (or −5 V) in the scanning period TS (FIG. 7). The potential of the signal lines Lb is 0 V from the end of the scanning period TS to the end of the light emission period TL (FIG. 7).

In other words, as illustrated in FIG. 8, the potential of the signal line Lb on the −D1 side of the second sub-pixel Sβ changes from +2 V to 0 V (or −2 V to 0 V) in the first display device 2a. As a result, a first capacitance C1 is formed between the signal line Lb and the second sub-pixel Sβ.

In the first display device 2a, the potential of the signal line Lb on the +D1 side of the second sub-pixel Sβ changes from +5 V to 0 V (or −5 V to 0 V). As a result, a second capacitance C2 is formed between the signal line Lb and the second sub-pixel Sβ.

The holding capacitance CS formed in the second sub-pixel Sβ changes due to the effects of the first capacitance C1 and the second capacitance C2. When the holding capacitance CS changes, the gradation level of the sub-pixel S changes. If the degree of change in the gradation level of the sub-pixel S differs between the first display device 2a and the second display device 2b, the difference in chromaticity may be relatively large between the image displayed by the first display device 2a and the image displayed by the second display device 2b.

To address this, the array of the sub-pixels S and the arrangement of the signal lines Lb are determined as described above in the first display device 2a and the second display device 2b.

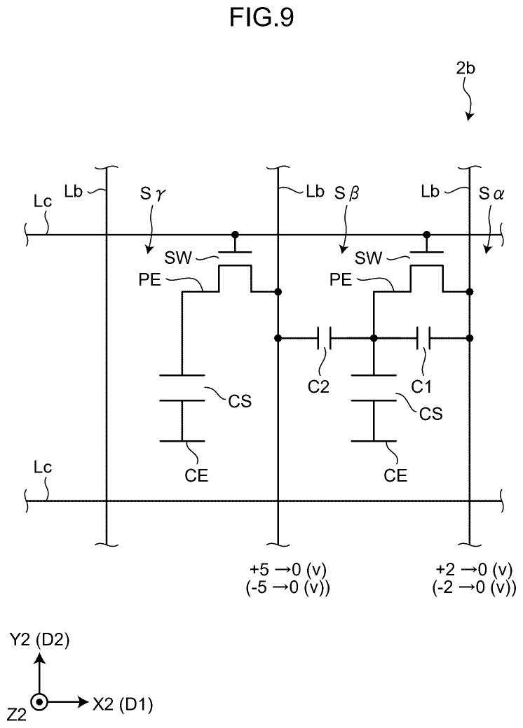

FIG. 9 is a partial enlarged view of the circuit configuration of the display panel 10 of the second display device 2b. FIG. 9 illustrates the second sub-pixel Sβ and the third sub-pixel Sγ electrically coupled to the same gate line Lc and adjacent to each other.

In the second display device 2b, the signal line Lb electrically coupled to the second sub-pixel Sβ is disposed on the +D1 side of the second sub-pixel Sβ, and the signal line Lb disposed on the −D1 side of the second sub-pixel Sβ is electrically coupled to the third sub-pixel Sγ adjacent to the second sub-pixel Sβ.

When the display device 2 displays cyan monochromatically in the entire display area DA, the potential of the signal line Lb on the +D2 side of the second sub-pixel Sβ changes from +2 V to 0 V (or −2 V to 0 V) in the second display device 2b. As a result, a first capacitance C1 is formed between the signal line Lb and the second sub-pixel Sβ. In the second display device 2b, the potential of the signal line Lb on the −D1 side of the second sub-pixel Sβ changes from +5 V to 0 V (or −5 V to 0 V). As a result, a second capacitance C2 is formed between the signal line Lb and the second sub-pixel Sβ.

Therefore, the holding capacitance CS formed in the second sub-pixel Sβ in the second display device 2b changes due to the effects of the first capacitance C1 and the second capacitance C2. As described above, the holding capacitance CS formed in the second sub-pixel Sβ in the first display device 2a also changes due to the effects of the first capacitance C1 and the second capacitance C2. In other words, the second sub-pixel Sβ of the first display device 2a and the second sub-pixel Sβ of the second display device 2b change due to the effects of the first capacitance C1 and the second capacitance C2 in the same manner.

Thus, the holding capacitance CS of the second sub-pixel Sβ is affected by the potential of the signal line Lb corresponding to the second sub-pixel Sβ and the potential of the signal line Lb corresponding to the third sub-pixel Sγ in both the first display device 2a and the second display device 2b. Therefore, the gradation level of the second sub-pixel Sβ changes in the same manner in the first display device 2a and the second display device 2b.

In the first display device 2a illustrated in FIG. 3, the signal line Lb electrically coupled to the third sub-pixel Sγ is disposed on the −D1 side of the third sub-pixel Sγ, and the signal line Lb disposed on the +D1 side of the third sub-pixel Sγ is electrically coupled to the first sub-pixel Sα adjacent to the third sub-pixel Sγ. By contrast, in the second display device 2b illustrated in FIG. 6, the signal line Lb electrically coupled to the third sub-pixel Sγ is disposed on the +D1 side of the third sub-pixel Sγ, and the signal line Lb disposed on the −D1 side of the third sub-pixel Sγ is electrically coupled to the first sub-pixel Sα adjacent to the third sub-pixel Sγ.

In other words, similarly to the second sub-pixel Sβ described above, the holding capacitance CS of the third sub-pixel Sγ is affected by the potential of the signal line Lb corresponding to the third sub-pixel Sγ and the potential of the signal line Lb corresponding to the first sub-pixel Sα in both the first display device 2a and the second display device 2b. Therefore, the gradation level of the third sub-pixel Sγ changes in the same manner in the first display device 2a and the second display device 2b.

In the first display device 2a illustrated in FIG. 3, the signal line Lb electrically coupled to the first sub-pixel Sα is disposed on the −D1 side of the first sub-pixel Sα, and the signal line Lb disposed on the +D1 side of the first sub-pixel Sα is electrically coupled to the second sub-pixel Sβ adjacent to the first sub-pixel Sα. By contrast, in the second display device 2b illustrated in FIG. 6, the signal line Lb electrically coupled to the first sub-pixel Sα is disposed on the +D1 side of the first sub-pixel Sα, and the signal line Lb disposed on the −D1 side of the first sub-pixel Sα is electrically coupled to the second sub-pixel Sβ adjacent to the first sub-pixel Sα.

In other words, similarly to the second sub-pixel Sβ described above, the holding capacitance CS of the first sub-pixel Sα is affected by the potential of the signal line Lb corresponding to the first sub-pixel Sα and the potential of the signal line Lb corresponding to the second sub-pixel Sβ in both the first display device 2a and the second display device 2b. Therefore, the gradation level of the first sub-pixel Sα changes in the same manner in the first display device 2a and the second display device 2b.

Thus, the gradation level of the first sub-pixel Sα, the gradation level of the second sub-pixel Sβ, and the gradation level of the third sub-pixel Sγ change in the same manner in the first display device 2a and the second display device 2b. Therefore, the difference in chromaticity can be reduced between the images displayed on the pair of display devices 1 when the same image is displayed on each one of the pair of display devices 1.

Next, a pair of display devices 1a according to a comparative example is described. The pair of display devices 1a according to the comparative example includes the first display device 2a similarly to the pair of display devices 1 according to the embodiment above. The pair of display devices 1a according to the comparative example is different from the pair of display devices 1 according to the embodiment above in that it includes a second display device 2ba instead of the second display device 2b. In other words, the pair of display devices 1a according to the comparative example includes the first display device 2a and the second display device 2ba.

The second display device 2ba according to the comparative example has the same configuration as that of the second display device 2b according to the embodiment above, except that the arrangement of the signal lines Lb is different from that of the second display device 2b according to the embodiment above. In other words, in the pair of display devices 1a according to the comparative example, the arrangement of the sub-pixels S in the display area DA of the first display device 2a and that of the sub-pixels S in the display area DA of the second display device 2ba are line symmetrical with respect to the virtual line Lv orthogonal to the X1-direction, but the arrangement of the signal lines Lb of the first display device 2a and that of the signal lines Lb of the second display device 2ba are not line symmetrical with respect to the virtual line Lv.

Specifically, the arrangement of the signal lines Lb in the second display device 2ba according to the comparative example is the same as that of the signal lines Lb in the first display device 2a according to the embodiment above (FIG. 3). In other words, in the second display device 2ba according to the comparative example, the m-th signal line Lb is disposed on the −D1 side of a plurality of sub-pixels S arrayed in the m-th column. The m-th signal line Lb branches off and is electrically coupled to the sub-pixels S arrayed in the m-th column.

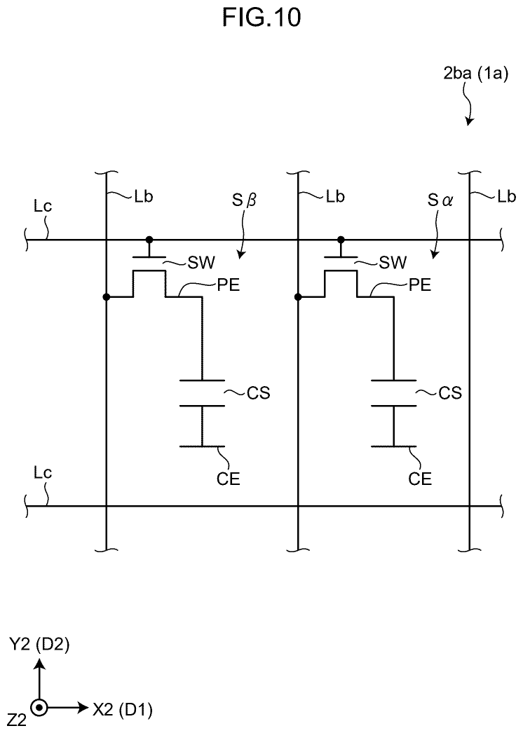

FIG. 10 is a partial enlarged view of the circuit configuration of the display panel 10 of the second display device 2ba in the pair of display devices 1a according to the comparative example. FIG. 10 illustrates the second sub-pixel Sβ and the first sub-pixel Sα electrically coupled to the same gate line Lc and adjacent to each other.

As illustrated in FIG. 10, the signal line Lb electrically coupled to the second sub-pixel Sβ is disposed on the −D1 side of the second sub-pixel Sβ, and the signal line Lb disposed on the +D1 side of the second sub-pixel Sβ is electrically coupled to the first sub-pixel Sα adjacent to the second sub-pixel Sβ. In other words, in the second display device 2ba according to the comparative example, the holding capacitance CS of the second sub-pixel Sβ is affected by the potential of the signal line Lb corresponding to the second sub-pixel Sβ and the potential of the signal line Lb corresponding to the first sub-pixel Sα.

By contrast, the pair of display devices 1a according to the comparative example includes the first display device 2a similarly to the pair of display devices 1 according to the embodiment above. Therefore, in the first display device 2a included in the pair of display devices 1a according to the comparative example, the holding capacitance CS of the second sub-pixel Sβ is affected by the potential of the signal line Lb corresponding to the second sub-pixel Sβ and the potential of the signal line Lb corresponding to the third sub-pixel Sγ.

Thus, in the pair of display devices 1a according to the comparative example, the holding capacitance CS of the second sub-pixel Sβ is affected by the potentials of the signal lines Lb corresponding to the different sub-pixels S between the first display device 2a and the second display device 2ba. In this case, the gradation level of the second sub-pixel Sβ may not change in the same manner in the first display device 2a and the second display device 2ba included in the pair of display devices 1a according to the comparative example. The same applies to the first sub-pixel Sα and the third sub-pixel Sγ. Therefore, the difference in chromaticity between the images displayed on the pair of display devices 1a according to the comparative example may be larger than that between the images displayed on the pair of display devices 1 according to the embodiment above.

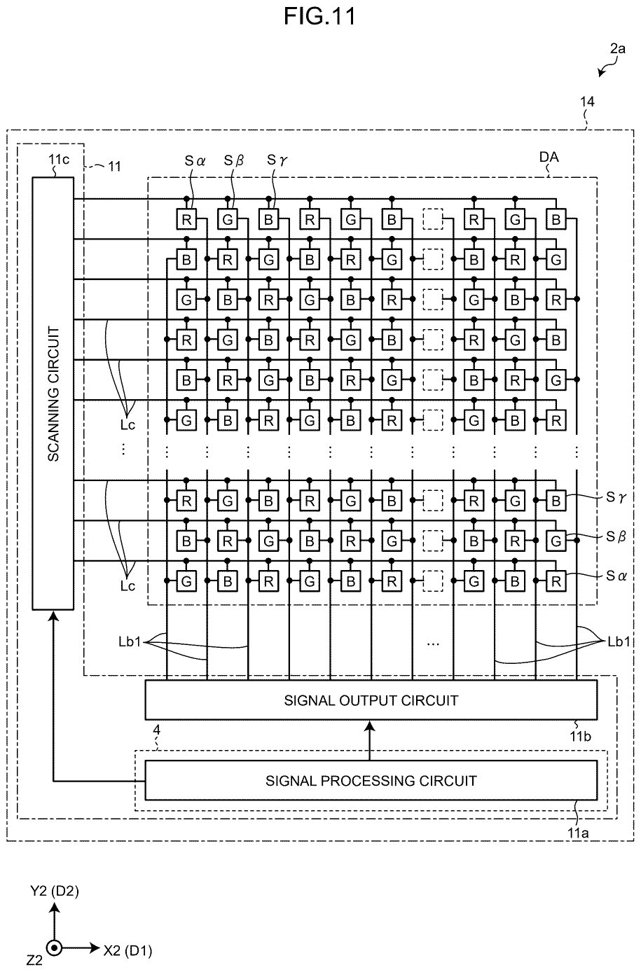

FIG. 11 is a diagram of the circuit configuration of the display panel 10 included in the first display device 2a in the pair of display devices 1 according to a modification of the embodiment of the present disclosure.

The first display device 2a according to the present modification and the first display device 2a according to the embodiment above have the same configuration except for the arrangement of the signal lines Lb.

A plurality of signal lines Lb1 included in the first display device 2a according to the present modification extends along the column direction D2 and are arrayed along the row direction D1 similarly to the first display device 2a according to the embodiment above. The signal lines Lb1 and the sub-pixels S are alternately arranged in the row direction D1.

The signal lines Lb1 included in the first display device 2a according to the present modification are different from the signal lines Lb of the first display device 2a according to the embodiment above as follows: when M is the total number of sub-pixels S arrayed in ascending order from the first column to the m-th column (m is a natural number) along the row direction D1 from the first end (end on the −D1 side) to the second end (end on the +D1 side), the total number of signal lines Lb1 is M+1. The first signal line Lb1 is disposed on the −D1 side of the sub-pixels S arrayed in the first column. The m-th signal line Lb1 branches off and is coupled to the sub-pixels S arranged in even-numbered rows of the m−1-th column and to the sub-pixel S arranged in odd-numbered rows of the m-th column.

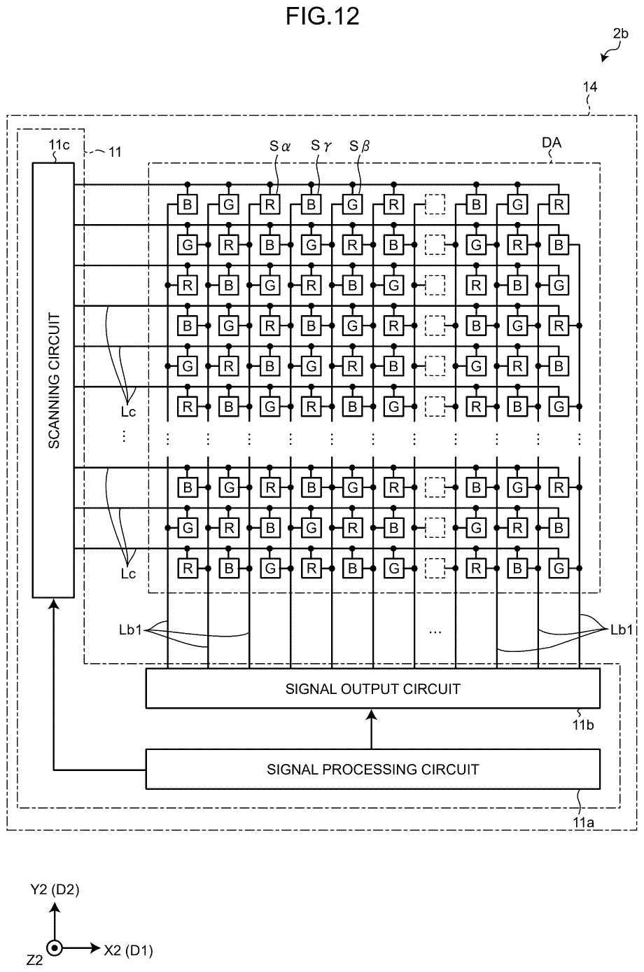

FIG. 12 is a diagram of the circuit configuration of the display panel 10 included in the second display device 2b in the pair of display devices 1 according to the modification of the embodiment of the present disclosure.

The second display device 2b according to the present modification and the second display device 2b according to the embodiment above have the same configuration except for the arrangement of the signal lines Lb.

A plurality of signal lines Lb1 included in the second display device 2b according to the present modification extends along the column direction D2 and are arrayed along the row direction D1 similarly to the second display device 2b according to the embodiment above. The signal lines Lb1 and the sub-pixels S are alternately arranged in the row direction D1.

The signal lines Lb1 included in the second display device 2b according to the present modification are different from the signal lines Lb of the second display device 2b according to the embodiment above in that the first signal line Lb1 is disposed on the −D1 side of the sub-pixels S arrayed in the first column. When M is the total number of sub-pixels S arrayed in ascending order from the first column to the m-th column (m is a natural number) along the row direction D1 from the first end (end on the −D1 side) to the second end (end on the +D1 side), the total number of signal lines Lb1 is M+1. The m-th signal line Lb1 branches off and is coupled to the sub-pixels S arranged in odd-numbered rows of the m−1-th row and to the sub-pixel S arranged in even-numbered rows of the m-th column.

By arranging the signal lines Lb1 in this manner, the arrangement of the signal lines Lb1 included in the first display device 2a according to the present modification and the arrangement of the signal lines Lb1 included in the second display device 2b according to the present modification are line symmetrical with respect to the virtual line Lv.

By arranging the signal lines Lb1 in this manner in the first display device 2a illustrated in FIG. 11, the signal line Lb1 electrically coupled to the first sub-pixel Sα in odd-numbered rows is disposed on the −D1 side of the first sub-pixel Sα, and the signal line Lb1 disposed on the +D1 side of the first sub-pixel Sα is electrically coupled to the second sub-pixel Sβ adjacent to the first sub-pixel Sα. By contrast, in the second display device 2b illustrated in FIG. 12, the signal line Lb1 electrically coupled to the first sub-pixel Sα in odd-numbered rows is disposed on the +D1 side of the first sub-pixel Sα, and the signal line Lb1 disposed on the −D1 side of the first sub-pixel Sα is electrically coupled to the second sub-pixel Sβ adjacent to the first sub-pixel Sα.

In other words, the holding capacitance CS of the first sub-pixel Sα in the odd-numbered rows is affected by the potential of the signal line Lb1 corresponding to the first sub-pixel Sα and the potential of the signal line Lb1 corresponding to the second sub-pixel Sβ in both the first display device 2a and the second display device 2b. Therefore, the gradation level of the first sub-pixel Sα in the odd-numbered rows changes in the same manner in the first display device 2a and the second display device 2b.

In the first display device 2a illustrated in FIG. 11, the signal line Lb1 electrically coupled to the first sub-pixel Sα in even-numbered rows is disposed on the +D1 side of the first sub-pixel Sα, and the signal line Lb1 disposed on the −D1 side of the first sub-pixel Sα is electrically coupled to the third sub-pixel Sγ adjacent to the first sub-pixel Sα. By contrast, in the second display device 2b illustrated in FIG. 12, the signal line Lb1 electrically coupled to the first sub-pixel Sα in even-numbered rows is disposed on the −D1 side of the first sub-pixel Sα, and the signal line Lb1 disposed on the +D1 side of the first sub-pixel Sα is electrically coupled to the third sub-pixel Sγ adjacent to the first sub-pixel Sα.

In other words, the holding capacitance CS of the first sub-pixel Sα in the even-numbered rows is affected by the potential of the signal line Lb1 corresponding to the first sub-pixel Sα and the potential of the signal line Lb1 corresponding to the third sub-pixel Sγ in both the first display device 2a and the second display device 2b. Therefore, the gradation level of the first sub-pixel Sα in the even-numbered rows changes in the same manner in the first display device 2a and the second display device 2b.

By arranging the signal lines Lb1 in this manner in the first display device 2a illustrated in FIG. 11, the signal line Lb1 electrically coupled to the second sub-pixel Sβ in odd-numbered rows is disposed on the −D1 side of the second sub-pixel Sβ, and the signal line Lb1 disposed on the +D1 side of the second sub-pixel Sβ is electrically coupled to the third sub-pixel Sγ adjacent to the second sub-pixel Sβ. By contrast, in the second display device 2b illustrated in FIG. 12, the signal line Lb1 electrically coupled to the second sub-pixel Sβ in odd-numbered rows is disposed on the +D1 side of the second sub-pixel Sβ, and the signal line Lb1 disposed on the −D1 side of the second sub-pixel Sβ is electrically coupled to the third sub-pixel Sγ adjacent to the second sub-pixel Sβ.

In other words, the holding capacitance CS of the second sub-pixel Sβ in the odd-numbered rows is affected by the potential of the signal line Lb1 corresponding to the second sub-pixel Sβ and the potential of the signal line Lb1 corresponding to the third sub-pixel Sγ in both the first display device 2a and the second display device 2b. Therefore, the gradation level of the second sub-pixel Sβ in the odd-numbered rows changes in the same manner in the first display device 2a and the second display device 2b.

In the first display device 2a illustrated in FIG. 11, the signal line Lb1 electrically coupled to the second sub-pixel Sβ in even-numbered rows is disposed on the +D1 side of the second sub-pixel Sβ, and the signal line Lb1 disposed on the −D1 side of the second sub-pixel Sβ is electrically coupled to the first sub-pixel Sα adjacent to the second sub-pixel Sβ. By contrast, in the second display device 2b illustrated in FIG. 12, the signal line Lb1 electrically coupled to the second sub-pixel Sβ in even-numbered rows is disposed on the −D1 side of the second sub-pixel Sβ, and the signal line Lb1 disposed on the +D1 side of the second sub-pixel Sβ is electrically coupled to the first sub-pixel Sα adjacent to the second sub-pixel Sβ.

In other words, the holding capacitance CS of the second sub-pixel Sβ in the even-numbered rows is affected by the potential of the signal line Lb1 corresponding to the second sub-pixel Sβ and the potential of the signal line Lb1 corresponding to the first sub-pixel Sα in both the first display device 2a and the second display device 2b. Therefore, the gradation level of the second sub-pixel Sβ in the even-numbered rows changes in the same manner in the first display device 2a and the second display device 2b.

By arranging the signal lines Lb1 in this manner in the first display device 2a illustrated in FIG. 11, the signal line Lb1 electrically coupled to the third sub-pixel Sγ in odd-numbered rows is disposed on the −D1 side of the third sub-pixel Sγ, and the signal line Lb1 disposed on the +D1 side of the third sub-pixel Sγ is electrically coupled to the first sub-pixel Sα adjacent to the third sub-pixel Sγ. By contrast, in the second display device 2b illustrated in FIG. 12, the signal line Lb1 electrically coupled to the third sub-pixel Sγ in odd-numbered rows is disposed on the +D1 side of the third sub-pixel Sγ, and the signal line Lb1 disposed on the −D1 side of the third sub-pixel Sγ is electrically coupled to the first sub-pixel Sα adjacent to the third sub-pixel Sγ.

In other words, the holding capacitance CS of the third sub-pixel Sγ in the odd-numbered rows is affected by the potential of the signal line Lb1 corresponding to the third sub-pixel Sγ and the potential of the signal line Lb1 corresponding to the first sub-pixel Sα in both the first display device 2a and the second display device 2b. Therefore, the gradation level of the third sub-pixel Sγ in the odd-numbered rows changes in the same manner in the first display device 2a and the second display device 2b.

In the first display device 2a illustrated in FIG. 11, the signal line Lb1 electrically coupled to the third sub-pixel Sγ in even-numbered rows is disposed on the +D1 side of the third sub-pixel Sγ, and the signal line Lb1 disposed on the −D1 side of the third sub-pixel Sγ is electrically coupled to the second sub-pixel Sβ adjacent to the third sub-pixel Sγ. By contrast, in the second display device 2b illustrated in FIG. 12, the signal line Lb1 electrically coupled to the third sub-pixel Sγ in even-numbered rows is disposed on the −D1 side of the third sub-pixel Sγ, and the signal line Lb1 disposed on the +D1 side of the third sub-pixel Sγ is electrically coupled to the second sub-pixel Sβ adjacent to the third sub-pixel Sγ.

In other words, the holding capacitance CS of the third sub-pixel Sγ in the even-numbered rows is affected by the potential of the signal line Lb1 corresponding to the third sub-pixel Sγ and the potential of the signal line Lb1 corresponding to the second sub-pixel Sβ in both the first display device 2a and the second display device 2b. Therefore, the gradation level of the second sub-pixel Sβ in the even-numbered rows changes in the same manner in the first display device 2a and the second display device 2b.

Thus, the gradation level of the first sub-pixel Sα, the gradation level of the second sub-pixel Sβ, and the gradation level of the third sub-pixel Sγ change in the same manner in the first display device 2a and the second display device 2b. Therefore, the pair of display devices 1 according to the present modification can also reduce the difference in chromaticity between the images displayed on the pair of display devices 1 when the same image is displayed on each one of the pair of display devices 1.

In the display device 2 according to the embodiment above, the drive circuit 11 may output the sub-pixel signals by a second column inversion driving method described below instead of the column inversion driving method described above.

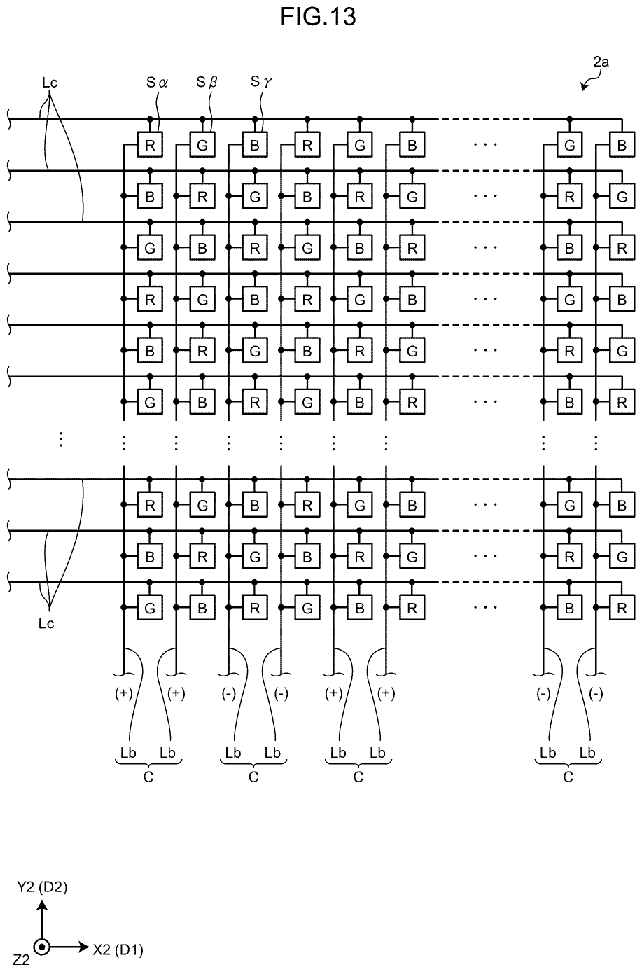

FIG. 13 is a diagram of a state where the drive circuit 11 included in the display device 2 outputs the sub-pixel signals by the second column inversion driving method in the pair of display devices 1 according to a modification of the embodiment of the present disclosure.

The signal lines Lb include a plurality of pairs of signal lines C. The pair of signal lines C is composed of two signal lines Lb adjacent to each other in the row direction D1. The pairs of signal lines C are sequentially arranged adjacent to each other along the row direction D1.

The second column inversion driving method is a driving method for the sub-pixels S. The second column inversion driving method is as follows: the polarities of the sub-pixel signals are the same in the two signal lines Lb included in the pair of signal lines C, the polarities of the sub-pixel signals are different between two pairs of signal lines C adjacent to each other in the row direction D1, and the polarities of the sub-pixel signals are periodically inverted. The symbols in the parentheses in FIG. 13 indicate the polarities of the sub-pixel signals at a certain timing.

Also in the case where the drive circuit 11 outputs the sub-pixel signals by the second column inverting driving method, the gradation level of the first sub-pixel Sα, the gradation level of the second sub-pixel Sβ, and the gradation level of the third sub-pixel Sγ change in the same manner in the first display device 2a and the second display device 2b. Therefore, the pair of display devices 1 according to the present modification can also reduce the difference in chromaticity between the images displayed on the pair of display devices 1 when the same image is displayed on each one of the pair of display devices 1.

### Display System 100

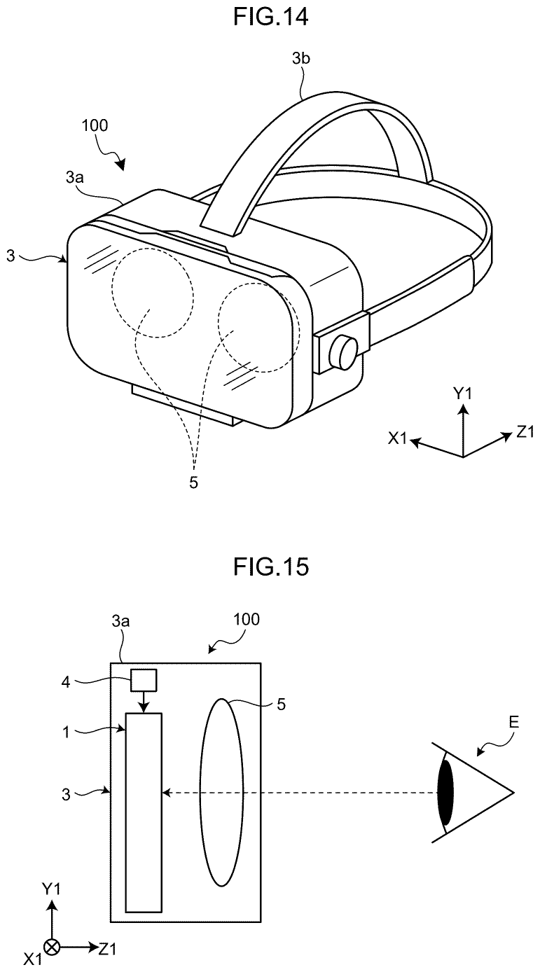

FIG. 14 is a perspective view of a display system 100 according to the embodiment of the present disclosure. FIG. 15 is a schematic diagram of the configuration of the display system 100. The display system 100 is, for example, a head-mounted display. The display system 100 displays images, such as computer graphic video images and 360-degree real video images.

The display system 100 includes a wearable part 3, a video signal source 4, two lenses 5, and the pair of display devices 1 described above.

Examples of the wearable part 3 include, but are not limited to, a headset, goggles, a helmet, a mask, etc. The wearable part 3 includes a body 3a and a belt 3b. The body 3a is provided with the video signal source 4, the two lenses 5, and the pairs of display devices 1. The belt 3b is wound around the user's head to fix the body 3a to the user's head. The wearable part 3 is worn on the user's head such that the body 3a covers both eyes of the user.

The video signal source 4 outputs image signals including information on images to the pair of display devices 1. The image signal includes two different images using the parallax of both eyes of the user. The two images are an image for the user's right eye and an image for the user's left eye and are substantially the same. The video signal source 4 outputs images stored therein in advance to the pair of display devices 1. The video signal source 4 includes, for example, a hard disk drive (HDD) and a flash memory. The video signal source 4 may be provided outside the wearable part 3. In this case, the video signal source 4 is a computer (e.g., server) electrically coupled to the pair of display devices 1 in a wired or wireless manner.

The two lenses 5 are disposed at the positions facing user's eyes E. The lens 5 is a convex lens made of glass, for example. The two lenses 5 correspond to the eyes of the user. The lenses 5 are disposed between the pair of display devices 1 and the user's eyes E. Due to the lens effects of the lens 5, light output from the pair of display devices 1 is condensed to the user's eyes E. The user visually recognizes an image obtained by enlarging the image being displayed on the pair of display devices 1.

The pair of display devices 1 is disposed opposite the user's eyes E with the two lenses 5 interposed therebetween.

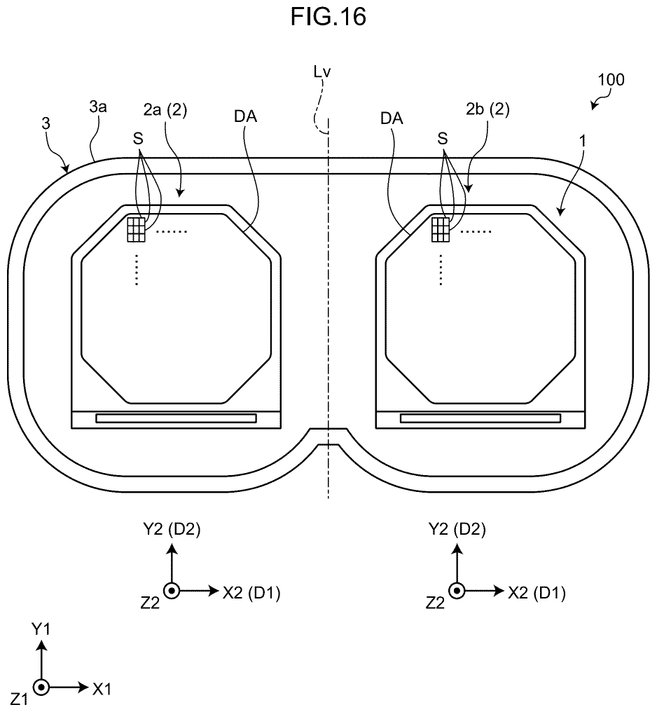

FIG. 16 is a schematic diagram of the arrangement of the pair of display devices 1 in the wearable part 3. The X1-direction of the pair of display devices 1 corresponds to the left and right direction of the user's eyes.

The first display device 2a acquires an image for the left eye from the video signal source 4. The display area DA of the first display device 2a faces the user's left eye and displays the image for the left eye. The second display device 2b acquires an image for the right eye from the video signal source 4. The display area DA of the second display device 2b faces the user's right eye and displays the image for the right eye.

In such a display system 100, the distance between the display area DA and the eyes is relatively small, and it is desirable to display high-definition images in the display area DA. Therefore, the pitch of two sub-pixels S adjacent to each other in the pair of display devices 1 is determined to be relatively small. Also in this case, by determining the array of the sub-pixels S and the arrangement of the signal lines Lb as described above, the difference in chromaticity can be reduced between the images displayed on the pair of display devices 1 when the same image is displayed on each one of the pair of display devices 1.

While the exemplary embodiment of the present disclosure has been described, the embodiment is not intended to limit the present disclosure. The contents disclosed according to the embodiment are given by way of example only, and various modifications may be made without departing from the spirit of the present disclosure. Appropriate modifications made without departing from the spirit of the present disclosure naturally fall within the technical scope of the present disclosure.

For example, the first end in the row direction D1 may be the end on the +D1 side, and the first end in the column direction D2 may be the end on the +D2 side. In this case, the first sub-pixel Sα, the second sub-pixel Sβ, and the third sub-pixel Sγ are repeatedly disposed in this order along the row direction D1 from the +D1 side to the −D1 side in the row direction D1 in plan view of the display area DA of the first display device 2a, and the first sub-pixel Sα, the second sub-pixel Sβ, and the third sub-pixel Sγ are repeatedly disposed in this order along the column direction D2 from the +D2 side to the −D2 side in the column direction D2.

The display panel 10 may be a vertical electric field liquid crystal display in which the common electrode CE is disposed on the second substrate 14 to face the sub-pixel electrodes PE. Alternatively, the display panel 10 may be a reflective liquid crystal display.

The X2-direction of the display device 2 may be inclined with respect to the X1-direction of the pair of display devices 1. The X2-direction of the first display device 2a may be inclined with respect to the X2-direction of the second display device 2b.

The drive circuit 11 includes, for example, a central processing unit (CPU), a read only memory (ROM), a random access memory (RAM), an internal storage, an input interface, and an output interface. The CPU, the ROM, the RAM, and the internal storage are coupled to each other through an internal bus. The ROM stores computer programs such as BIOS. The internal storage is, for example, a hard disk drive (HDD) or a flash memory and stores an operating system program and application programs. The CPU implements various kinds of functions by executing computer programs stored in the ROM or the internal storage while using the RAM as a work area.

Out of other advantageous effects achieved by the aspects described in the present embodiment, advantageous effects clearly defined by the description in the present specification or appropriately conceivable by those skilled in the art are naturally achieved by the present disclosure.

What is claimed is:

1. A pair of display devices comprising
a first display device and a second display device arranged along an array direction, wherein
the first display device and the second display device each comprise:
a display panel having a display area in which a plurality of sub-pixels are arrayed in a matrix having a row-column configuration along a row direction and a column direction;
a plurality of gate lines provided to the display panel, extending along the row direction, and arrayed along the column direction;
a plurality of signal lines provided to the display panel, extending along the column direction, and arrayed along the row direction; and
a drive circuit configured to output sub-pixel signals for displaying an image in the display area to the sub-pixels via the signal lines and drive the sub-pixels via the gate lines,
the sub-pixels include a plurality of first sub-pixels, a plurality of second sub-pixels, and a plurality of third sub-pixels having different colors,
the first sub-pixels, the second sub-pixels, and the third sub-pixels are arranged in the display area of the first display device such that the first sub-pixel, the second sub-pixel, and the third sub-pixel are repeatedly disposed along the row direction in the order as listed and that the first sub-pixel, the second sub-pixel, and the third sub-pixel are repeatedly disposed along the column direction in the order as listed,
an arrangement of the sub-pixels in the display area of the first display device and an arrangement of the sub-pixels in the display area of the second display device are line symmetrical with respect to a virtual line orthogonal to the array direction, and
an arrangement of the signal lines of the first display device and an arrangement of the signal lines of the second display device are line symmetrical with respect to the virtual line.

2. The pair of display devices according to claim 1, wherein
when M is the total number of the sub-pixels arrayed in ascending order from the first column to the m-th column (m is a natural number) along the row direction from a first end to a second end,
the total number of the signal lines is M and
the m-th signal line is electrically coupled to the sub-pixels arrayed in the m-th column in each of the first display device and the second display device.

3. The pair of display devices according to claim 1, wherein
when M is the total number of the sub-pixels arrayed in ascending order from the first column to the m-th column (m is a natural number) along the row direction from a first end to a second end,
the total number of the signal lines is M+1 and
the m-th signal line in the first display device is coupled to the sub-pixels arranged in even-numbered rows of the m−1-th column and to the sub-pixels arranged in odd-numbered rows of the m-th column, and
the m-th signal line in the second display device is coupled to the sub-pixels arranged in odd-numbered rows of the m−1-th column and to the sub-pixels arranged in even-numbered rows of the m-th column.

4. The pair of display devices according to claim 1, wherein the drive circuit outputs the sub-pixel signals by a column inversion driving method in which polarities of the sub-pixel signals are different between two of the signal lines adjacent to each other in the row direction and the polarities of the sub-pixel signals are periodically inverted.

5. The pair of display devices according to claim 1, wherein
the signal lines include a plurality of pairs of signal lines including two of the signal lines adjacent to each other in the row direction,
the pairs of signal lines are sequentially arranged adjacent to each other along the row direction, and
the drive circuit outputs the sub-pixel signals by a second column inversion driving method in which polarities of the sub-pixel signals are the same in the two signal lines included in the pair of signal lines, the polarities of the sub-pixel signals are different between two of the pairs of signal lines adjacent to each other in the row direction, and the polarities of the sub-pixel signals are periodically inverted.

6. The pair of display devices according to claim 1, wherein
each of the first sub-pixels is a red sub-pixel,
each of the second sub-pixels is a green sub-pixel, and
each of the third sub-pixels is a blue sub-pixel.

7. A display system comprising:
the pair of display devices according to claim 1; and
a lens.
